(19) United States
(12) Patent Application Publication
(10) Pub. No.: US 2009/0024588 A1
(43) Pub. Date: Jan. 22, 2009

(54) METHODS AND SYSTEMS FOR SEARCHING FOR INFORMATION

(75) Inventor: Hsueh-Feng Shih, Taoyuan (TW)

Correspondence Address: QUINTERO LAW OFFICE, PC, 2210 MAIN STREET, SUITE 200, SANTA MONICA, CA, 90405, US

(73) Assignee: NANYA TECHNOLOGY CORPORATION, TAOYUAN (TW)

(21) Appl. No.: 11/937,457

(22) Filed: Nov. 8, 2007

(30) Foreign Application Priority Data
Jul. 16, 2007 (TW) TW96125836

(51) Int. Cl. G06F 17/30

(52) U.S. Cl. 707/3; 707/E17.014

(57) ABSTRACT

Methods and systems for searching for information. First, a classification code corresponding to a specific classification is received. At least a first keyword is selected from a plurality of keywords in a keyword bank corresponding to the classification code. Information is searched for according to the first keyword.

### BACKGROUND OF THE INVENTION

1. Field of the Invention

The disclosure relates generally to methods and systems for searching, for information, and, more particularly to methods and systems that search for related data according to historical keywords.

2. Description of the Related Art

When users search for information, they must determine appropriate keywords by themselves, and then input the keywords to a search engine to search for the desired information accordingly. Generally, it is difficult to accurately determine the keywords Users often spend more time than allotted to think, and try to figure out the right keywords by trial and error, in order to obtain desired search information. One notable example occurs during patent searches. Users often find it hard to accurately determine keywords to efficiently search for prior arts and applications related to specific technologies or patents.

### BRIEF SUMMARY OF THE INVENTION

Methods and systems for searching for information are provided.

In an embodiment of a method for searching for information, a classification code corresponding to a specific classification is received. At least a first key word is selected from a plurality of keywords in a keyword bank corresponding to the classification code. Information is searched for according to the first keyword.

An embodiment of a system for searching for information comprises a reception unit, a storage unit, and a processing unit. The reception unit receives a classification code corresponding to a specific classification. The storage unit comprises a keyword bank corresponding to the classification code, wherein the keyword bank comprises a plurality of keywords. The processing unit receives a selection of a first keyword among the keywords in the keyword bank corresponding to the classification code via the reception unit, and searches for information according to the first keyword.

Methods and systems for searching for information may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for searching for information;

FIG. 2 is a schematic diagram illustrating an embodiment of a storage unit;

FIG. 3 is an example of classification codes and corresponding technology fields; and

FIG. 4 is a flowchart of an embodiment of a method for searching for information.

### DETAILED DESCRIPTION OF THE INVENTION

Methods and systems for searching for information are provided.

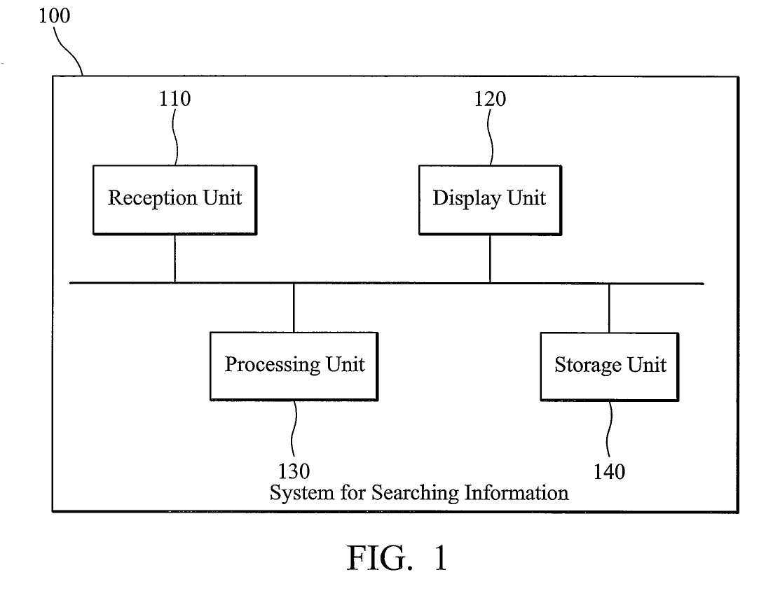

FIG. 1 is a schematic diagram illustrating an embodiment of a system for searching for information. The system 100 comprises a reception unit 110, a display unit 120, a processing unit 130, and a storage unit 140. The reception unit 110 receives inputs and selections from users. The display unit 120 displays related information, such as related keywords, retrieved information, corresponding data, and others. The processing unit 130 performs the methods for searching for information. The storage unit 140 stores keywords in the keyword bank corresponding to the classification code. More details are discussed later. It is understood that the system 100 for searching for information may be structured in a single host, or client-server architecture. In an embodiment of the client-server architecture, the display unit 120 of the system 100 may be located at the client. The system 100 can receive requests for searching for information from the client.

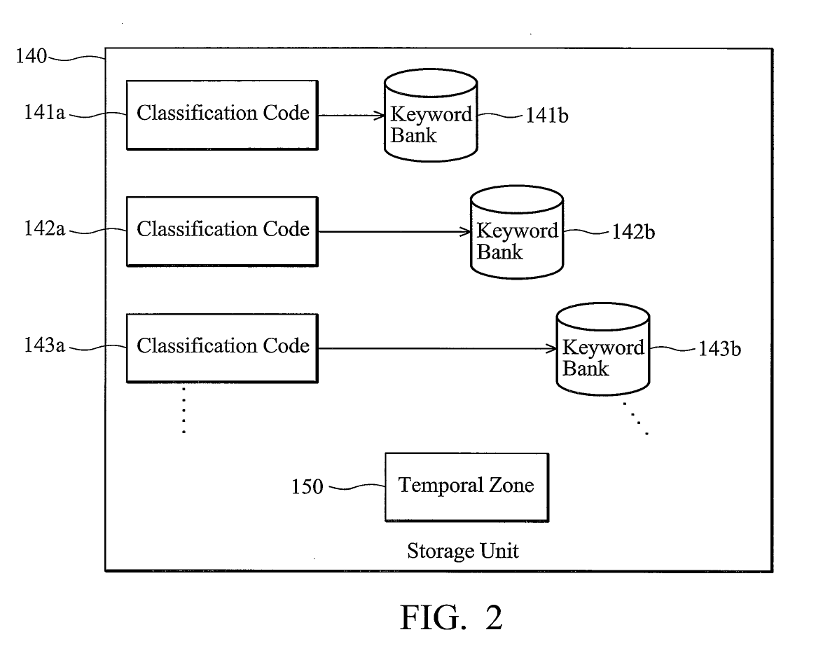

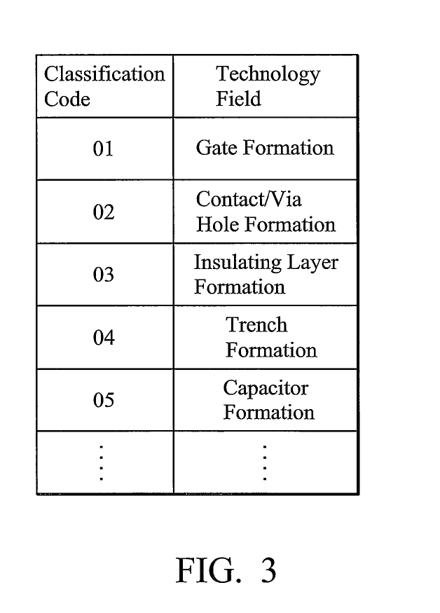

FIG. 2 is a schematic diagram illustrating an embodiment of a storage unit. As shown in FIG. 2, the storage unit 140 comprises keyword banks corresponding to various classification codes. The keyword bank 141b corresponds to the classification codes 141a, the keyword bank 142b corresponds to the classification codes 142a, and the keyword bank 143b corresponds to the classification codes 143a. Respective keyword banks store a plurality of keywords for a specific classification corresponding to the classification code. It is noted that, each keyword may be a single keyword or a combination of multiple keywords. In some embodiments, the keyword combination may be a logic combination with condition syntax, wherein respective keyword in the keyword combination may have a corresponding logic operator. Additionally, the storage unit 140 comprises a temporal zone 150. The use of the temporal zone 150 will be discussed later. It is noted that, in some embodiments, the temporal zone 150 may be a stand-alone from the storage unit 140. It is understood that respective classification codes correspond to different specific classifications. In this embodiment, the classification codes may correspond to different technology fields. FIG. 3 is an example of classification codes and corresponding technology fields. As shown in FIG. 3, the technology field corresponding to classification code “01” is “gate formation”, the technology field corresponding to classification code “02” is “contact/via hole formation”, the technology field corresponding to classification code “03” is “insulating layer formation”, the technology field corresponding to classification code “04” is “trench formation”, and the technology field corresponding to classification code “05” is “capacitor formation”. It is noted that the classification principle can be based on various requirements, and is not limited thereto.

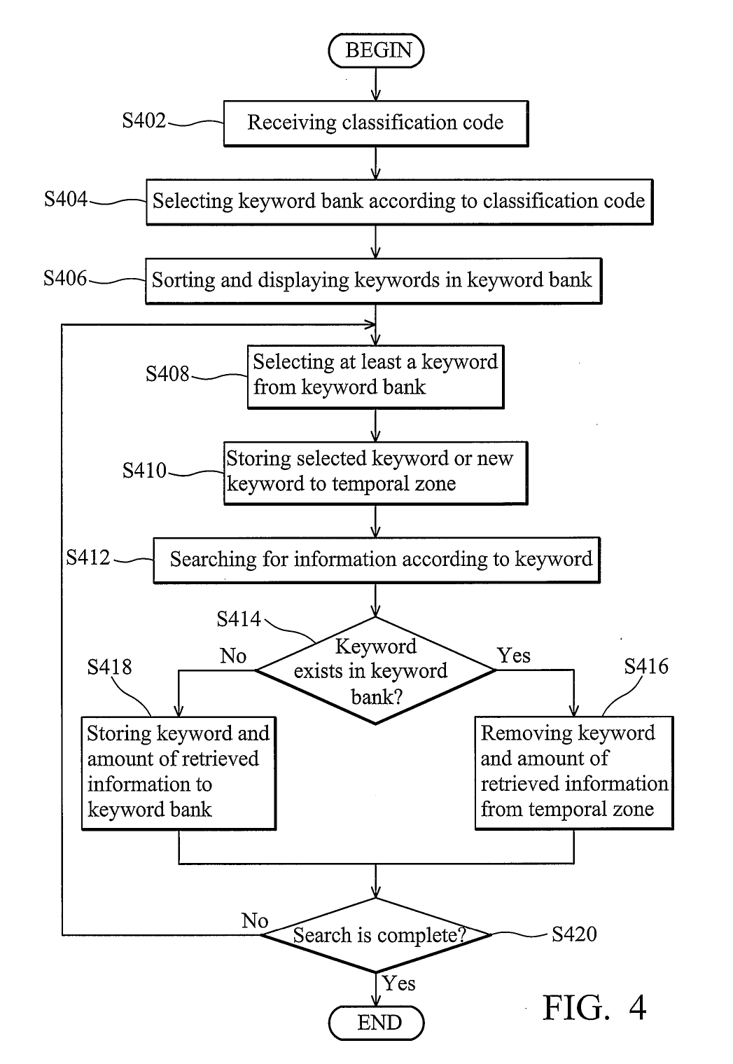

FIG. 4 is a flowchart of an embodiment of a method for searching for information.

In step S402, a classification code is received, and in step S404, a keyword bank corresponding to the received classification code is selected. In step S406, keywords in the selected keyword bank are sorted and displayed. For example, the keyword bank corresponding to the classification code “01” of the technology field “gate formation” in FIG. 3 comprises keywords “gate”, “depo”, “etch”, “remove”, “channel”, “wet etch”, “pull back”, “recess”, “conductor”, “poly”, “isotropy”, “nitride”, “undercut”, and logic combinations of the keywords, such as (abst/(gate and “pull back”) and undercut). It is understood that the number of retrieved patent documents corresponding to the keyword will be recorded in the keyword bank during each patent search. The keywords are sorted according to the corresponding amounts of the retrieved information in step S406. In step S408, at least one keyword is selected among the keywords, and in step S410, the selected keyword or a new keyword is stored to the temporal zone. It is noted that the new keyword is generated according to the selected keyword. In some embodiments, if two keywords are selected from the keyword bank, the selected keywords can be combined using logic operators such as AND, OR, and NOT to generate a new keyword. It is also understood that, in some embodiments, users can directly input a specific keyword. The input keyword can be also combined with the keywords in the keyword bank to generate a new keyword. Then, in step S412, information is searched for, according to the keyword (selected keyword or new keyword). The retrieved information will be displayed, and the amount of retrieved information will be recorded in the temporal zone. In step S414, it is determined whether the keyword exists in the keyword bank corresponding to the classification code. If so (Yes in step S414), in step S416, the keyword and the corresponding amount of retrieved information are removed from the temporal zone. If not (No in step S414), in step S418, the keyword and the corresponding amount of retrieved information are stored to the keyword bank. Thereafter, in step S420, it is determined whether the information search is complete. If so (Yes in step S420), the procedure is completed. If not (No in step S420), the procedure returns to step S408, another keyword is selected for further search. In some embodiments, after an information search, the system will display a user interface or selection to determine whether another information search is required. If another information search is required, the keywords in the keyword bank corresponding to the classification code received in step S402 and the corresponding amounts of retrieved information are displayed.

In the methods and systems for searching for information, when users search for information corresponding to certain classification codes, they can directly refer to the existed keywords, or combine the keywords into new keywords for search. The new keywords will be stored to the keyword bank to accumulate the keywords for reference, thus saving time for the user by assisting in the trial and error process during keyword search.

Methods and systems for searching for information, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for searching for information, comprising:
receiving a classification code corresponding to a specific classification;
selecting at least a first keyword from a plurality of keywords in a keyword bank corresponding to the classification code; and
searching for information according to the first keyword.

2. The method of claim 1 further comprising:
selecting a second keyword from the keywords in the keyword bank corresponding to the classification code;
generating a third keyword according to the first keyword and the second keyword; and
searching for information according to the third keyword.

3. The method of claim 2 further comprising:
determining whether the third keyword exists in the keyword bank corresponding to the classification code; and
if not, storing the third keyword to the keyword bank corresponding to the classification code.

4. The method of claim 2 further comprising inputting the third keyword to a temporal zone.

5. The method of claim 4 further comprising:
determining whether the third keyword exists in the keyword bank corresponding to the classification code; and
if so, removing the third keyword from the temporal zone.

6. The method of claim 2 wherein the third keyword is a logic combination of the first keyword and the second keyword.

7. The method of claim 1 further comprising:
receiving an input of a fourth keyword;
generating a fifth keyword according to the first keyword and the fourth keyword; and
searching for information according to the fifth keyword.

8. The method of claim 7 further comprising:
determining whether the fifth keyword exists in the keyword bank corresponding to the classification code; and
if not, storing the fifth keyword to the keyword bank corresponding to the classification code.

9. The method of claim 7 further comprising inputting the fifth keyword to a temporal zone.

10. The method of claim 9 further comprising:
determining whether the fifth keyword exists in the keyword bank corresponding to the classification code; and
if so, removing the fifth keyword from the temporal zone.

11. The method of claim 7 wherein the fifth keyword is a logic combination of the first keyword and the fourth keyword.

12. The method of claim 3 further comprising:
recording an amount of the retrieved information corresponding to the third keyword; and
storing the third keyword and the corresponding amount of the retrieved information to the keyword bank corresponding to the classification code when the third keyword does not exist in the keyword bank corresponding to the classification code.

13. The method of claim 1 further comprising displaying the keywords in the keyword bank corresponding to the classification code, and corresponding amounts of retrieved information of the respective keywords.

14. The method of claim 1 further comprising:
determining whether the first keyword exists in the keyword bank corresponding to the classification code; and
if not, storing the first keyword to the keyword bank corresponding to the classification code.

15. The method of claim 1 wherein the specific classification is classified based on technology fields.

16. A system for searching for information, comprising:
a reception unit receiving a classification code corresponding to a specific classification;
a storage unit comprising a keyword bank corresponding to the classification code, wherein the keyword bank comprises a plurality of keywords; and
a processing unit receiving a selection of at least a first keyword from the keywords in the keyword bank corresponding to the classification code via the reception unit, and searching for information according to the first keyword.

17. The system of claim 16 wherein the processing unit further receives a selection of a second keyword from the keywords in the keyword bank corresponding to the classification code via the reception unit, generates a third keyword according to the first keyword and the second keyword, and searches for information according to the third keyword.

18. The system of claim 17 wherein the processing unit further determines whether the third keyword exists in the keyword bank corresponding to the classification code, and if not, stores the third keyword to the keyword bank corresponding to the classification code.

19. The system of claim 17 wherein the processing unit further inputs the third keyword to a temporal zone.

20. The system of claim 19 wherein the processing unit further determines whether the third keyword exists in the keyword bank corresponding to the classification code, and if so, removes the third keyword from the temporal zone.

21. The system of claim 17 wherein the third keyword is a logic combination of the first keyword and the second keyword.

22. The system of claim 18 wherein the processing unit further records an amount of the retrieved information corresponding to the third keyword, and stores the third keyword and the corresponding amount of the retrieved information to the keyword bank corresponding to the classification code when the third keyword does not exist in the keyword bank corresponding to the classification code.

23. The system of claim 16 further comprising a display unit displaying the keywords in the keyword bank corresponding to the classification code, and corresponding amounts of retrieved information of the respective keywords.

24. The system of claim 16 wherein the processing unit further determines whether the first keyword exists in the keyword bank corresponding to the classification code, and if not, stores the first keyword to the keyword bank corresponding to the classification code.
